(19) United States
(12) Patent Application Publication
(10) Pub. No.: US 2014/0281474 A1
(43) Pub. Date: Sep. 18, 2014

(54) System and Method for Unattended Out of Band Job Execution

(71) Applicants: Mark W. Shutt, Austin, TX (US); Sundar Dasar, Round Rock, TX (US); Yogesh Prabhkar Kulkarni, Round Rock, TX (US)

(72) Inventors: Mark W. Shutt, Austin, TX (US); Sundar Dasar, Round Rock, TX (US); Yogesh Prabhkar Kulkarni, Round Rock, TX (US)

(21) Appl. No.: 13/846,052

(22) Filed: Mar. 18, 2013

(51) Int. Cl. G06F 9/445

(52) U.S. Cl. CPC G06F 9/44505
USPC 713/100

(57) ABSTRACT

Systems and method for providing unattended out of band job execution are disclosed. The systems and methods may include scheduling a job for execution by a host system, determining an attribute value, the attribute value associated a component of the host system, and determining a shadow attribute value, wherein the shadow attribute value is configured to identify a user interaction associated with a configuration change to the component.

### TECHNICAL FIELD

This invention relates generally to the field of information handling systems and more specifically to providing unattended out of band job execution.

### BACKGROUND

As the value and use of information continues to increase, individuals and businesses seek additional ways to process and store information. One option available to users is information handling systems (“information handling systems”). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the ubiquity of information handling systems increases, so does the number of information handling systems used by a particular enterprise. As changes are rolled out to these information handling systems, an increasing number of enterprises are turning to remote management of large numbers of information handling systems.

### SUMMARY OF THE DISCLOSURE

In accordance with certain embodiments of the present disclosure, systems and method for providing unattended out of band job execution are disclosed. The systems and methods may include scheduling a job for execution by a host system, determining an attribute value, the attribute value associated a component of the host system, and determining a shadow attribute value, wherein the shadow attribute value is configured to identify a user interaction associated with a configuration change to the component.

### BRIEF DESCRIPTION OF THE DRAWINGS

For a more complete understanding of the present invention and its advantages, reference is now made to the following description, taken in conjunction with the accompanying drawings, in which:

FIG. 1 illustrates an example system for providing unattended out of band job execution flow, in accordance with certain embodiments of the present disclosure;

FIG. 2 illustrates a flowchart of an example method for providing unattended out of band job execution commands by service IHS, in accordance with certain embodiments of the present disclosure; and

FIG. 3 illustrates a flowchart of an example method for performing unattended out of band job execution by host IHS, in accordance with certain embodiments of the present disclosure.

### DETAILED DESCRIPTION OF THE INVENTION

For the purposes of this disclosure, an information handling system (“information handling system”) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system (“IHS”) may include memory, one or more processing resources, such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

FIG. 1 illustrates an example system 100 for providing unattended out of band job execution flow, in accordance with certain embodiments of the present disclosure. In some embodiments, system 100 may include service IHS 102 communicatively coupled to one or more host IHS 104. In some embodiments, service IHS 102 and host IHS 104 may be communicatively coupled via any appropriate communications network 118. For example, service 102 and host IHS 104 may be configured to communicate via ethernet, cellular, and/or other appropriate communication network. In the same or alternative embodiments, service IHS 102 and host IHS 104 may be configured to communicate with one another via different communication networks. For example, service IHS 102 may be configured to communicate with one or more host IHS 104 via a local area network (e.g., over ethernet) while service IHS 102 may be configured to communicate with the same or other host IHS 104 via a wide area network (e.g., over a cellular data network).

In some embodiments, service IHS 102 may include one or more processor(s) 106 communicatively coupled to one or more memories 108. Processor 106 and memory 108 may be any microprocessor, microcontroller, digital signal processor, and/or other processor configured to execute instructions stored on memory 108. Memory 108 may be any nonvolatile memory configured to store instructions for execution by processor 106. In the same or alternative embodiments, host IHS 104 may include one or more processor(s) 110 communicatively coupled to one or more memories 112. Processor 110 and memory 112 may be any microprocessor, microcontroller, digital signal processor, and/or other processor configured to execute instructions stored on memory 112. Memory 112 may be any nonvolatile memory configured to store instructions for execution by processor 110.

As described in more detail below with reference to FIGS. 2-3, in operation service IHS 102 may be configured to provide unattended out of band job execution flow. In some embodiments of system 100, service IHS 102 may be configured to provide data associated with certain configuration changes to one or more host IHS 104. For example, service IHS 102 may be configured to provide configuration settings to a large number of host IHS 104. Such an example configuration may be found in large server management systems where a given configuration may need to be applied to a large number of servers.

In some embodiments, configuration changes to host IHS 104 may require a user of host IHS 104 to confirm that the change has been made. In situations in which the user of host IHS 104 is local to host IHS 104, these confirmations may be relatively simple to perform. However, in some configurations of system 100 the administrator responsible for confirming changes to host IHS 104 may be remote from host IHS 104. This type of remote management may be referred to as “out of band” execution. In certain configurations of out of band job execution, there may be no user local to host IHS 104 to confirm configuration changes. As described above, in configurations of system 100 in which a large number of host IHS 104 must be configured, it may be inefficient for a user to locally confirm changes for each host IHS 104.

In some embodiments of system 100, once configuration changes are made to host IHS 104, components of host IHS 104 may implement the changes during a “post” operation. In some configurations, part of the post operation may include the confirmation of the configuration changes.

In some embodiments, host IHS 104 may have associated with it a plurality of attributes used to configure settings. Attributes may be data associated with various parameters of components 114 of host IHS 104. Components 114 of host IHS 104 may be any appropriate component configured to receive configuration settings. For example, component 114 may include subsystems, modules, hardware, and/or other components of host IHS 104 configured to receive configuration updates from service IHS 104. As an illustration, components 114 may include the BIOS, NIC, RAID controller, etc. associated with host IHS 104.

In some embodiments, host IHS 104 may receive configuration updates from service IHS 104 via one or more interface(s) via communications network 118. An interface may be any interface toolkit, protocol, communication path, or other interface configured to provide configuration updates to components 114 of host IHS 104. For example, interfaces may include Lifecycle Controller Remote Enablement, Dell Deployment Toolkit, etc.

In some embodiments, components 114 may be configured to have access to data associated with a first, earlier value for an attribute as well as data associated with a second, later value for the same attribute. This first, earlier value may be referred to as a “shadow attribute.”

In some embodiments, interface may be configured to modify shadow attributes. For example, each attribute may include dependency information. This dependency information may take the form of modifiers that may only be interpreted by an out of band user. An illustrative example of such modifiers includes modifiers such as “ForceIf” (to force an attribute value based on a condition described in the modifier) and “ReadonlyIf” (to make an attribute read-only based on a condition described in the modifier). Interface may be configured to apply the modifier, keeping an attribute and its associated shadow attribute in sync.

During the post process, component 114 associated with interface may be configured to compare an attribute value and its associated shadow attribute value in order to determine if a configuration change has been made, and therefore whether user confirmation is required. If interface has forced a change to the shadow attribute value in order to make it match the attribute value, component 114 may not see that a configuration change has been made, and therefore may not seek user confirmation.

In operation, an interface may make a number of shadow attribute changes during out of band job execution. The following is provided as an illustrative example in order to aid in understanding and is not intended to limit the scope of the present disclosure. One of ordinary skill in the art may recognize that more, fewer, or different attribute values, components, modifiers, and/or other changes to the illustrative example may be made without departing from the scope of the present disclosure.

For example, host IHS 104 may include a Serial ATA (“SATA”) controller with an associated attribute denoted “EMBSATA.” EMBSATA may have a shadow attribute denoted “EMBSATAShadow.” The example possible values for EMBSATA may include: (1) AtaMode, (2) AhciMode, (3) RaidMode, and (4) Off. In such a configuration, the example possible values for EMBSATAShadow may include, respectively: (1) AtaMode [ForceIf:EMBSATA=AtaMode]; (2) AhciMode [ForceIf:EMBSATA=AhciMode]; (3) RaidMode [ForceIf:EmSata=RaidMode]; and (4) Off [ForceIf;EMBSATA=Off].

During a post operation, component 114 (e.g., a BIOS and/or Option ROM) may compare the EMBSATA and EMBSATAShadow values. If they are different, component 114 may choose to prompt a user to confirm the changes. For example, if the EMBSATA and EMBSATAShadow values are different, it may indicate that the mode for component 114 is changing. Component 114 may then sync the attribute value and shadow attribute value so that i can detect further changes. The modifiers contained within the shadow attribute may be configured to cause interface to always synchronize EMBSATA and EMBSATAShadow, and may therefore avoid user confirmation.

In some embodiments, system 100 may be configured to provide out of band job execution across a wide range of vendors, devices, machines, arrangements, modules, and/or other components and/or suppliers of components. Component 114 and/or adapters for or to component 114 may be implemented in system 100 without departing from the scope of the present disclosure. Further, in some embodiments, system 100 may be configured to include a plurality of components 114 present in a plurality of host IHS 104, wherein each component 114 may be of a different type, make, model, vendor, etc.

As described in more detail below, service IHS 102 and host IHS 104 may work together to use shadow attributes to provide unattended out of band job execution.

FIG. 2 illustrates a flowchart of an example method 200 for providing unattended out of band job execution commands by service IHS 102, in accordance with certain embodiments of the present disclosure. Method 200 may include scheduling the out of band job, identifying appropriate attributes, and setting the attribute values.

According to one embodiment, method 200 preferably begins at step 202. Teachings of the present disclosure may be implemented in a variety of configurations. As such, the preferred initialization point for method 200 and the order of steps 202-210 comprising method 200 may depend on the implementation chosen.

At step 202, method 200 may schedule an out of band job for execution, as described in more detail above with reference to FIG. 1. For example, service IHS 102 may prepare to update configurations to a large numbers of host IHS 104, including updates for which a post process is required by the BIOS and/or Option ROM of each host IHS 104. As described in more detail above with reference to the illustrative example of FIG. 1, this may include, for example, an update to the attribute values associated with a SATA controller. After scheduling the job, method 200 may proceed to step 204.

At step 204, method 200 may determine whether the attribute values to be set require setting shadow attributes, as described in more detail above with reference to FIG. 1. For example, if no change is made to component 114, there may be changes to the shadow attributes, if setting shadow attributes is required, method 200 may continue to step 206. If not, method 200 may continue to step 208.

At step 206, method 200 may set the pending value(s) for the relevant shadow attributes, as described in more detail above with reference to FIG. 1. For example, the shadow attribute may be set to force the value based on the current value of the attribute value. Once the values are set, method 200 may continue to step 208.

At step 208, method 200 may set the pending values for user-configured attributes. After setting these values, method 200 may continue to step 210. At step 210, method 200 may send instructions to host IHS 104 to reboot, as described in more detail above with reference to FIG. 1 and below with reference to FIG. 3. Once the reboot process has begun, method 200 may return to step 202.

Although FIG. 2 discloses a particular number of steps to be taken with respect to method 200, method 200 may be executed with more or fewer steps than those depicted in FIG. 2. In addition, although FIG. 2 discloses a certain order of steps comprising method 200, the steps comprising method 200 may be completed in any suitable order. For example, in the embodiment of method 200 shown, the setting of shadow attributes and user-configured attributes is shown as two separate, dependent steps. However, in some configurations, these two steps may be performed simultaneously and/or in phases to the extent possible.

FIG. 3 illustrates a flowchart of an example method 300 for performing unattended out of band job execution by host IHS 102, in accordance with certain embodiments of the present disclosure. Method 300 may include executing the pre-boot application, checking for shadow attributes, and waiting for any necessary user interaction.

According to one embodiment, method 300 preferably begins at step 302. Teachings of the present disclosure may be implemented in a variety of configurations. As such, the preferred initialization point for method 300 and the order of steps 302-316 comprising method 300 may depend on the implementation chosen.

At step 302, method 300 may launch a pre-boot application. In some embodiments, component 114 may launch the pre-boot application. For example, the BIOS of host IHS 104 may launch the pre-boot application. After launching the application, method 300 may proceed to step 304. At step 304, method 300 may complete the out of band job by, among other things, setting one or more requested attributes along with the associated shadow attributes, as described in more detail above with reference to FIGS. 1-2. After setting the attribute values, method 300 may proceed to step 306.

At step 306, method 300 may reset host IHS 104. In some embodiments, this may be performed by the pre-boot application. After reset, method 300 may proceed to step 308. At step 308, method 300 may check for shadow attribute values. In some embodiments, component 114 of host IHS 104 may check these shadow attribute values, as described in more detail above with reference to FIGS. 1-2. After checking the shadow attribute values, method 300 may proceed to step 310.

At step 310, method 300 may determine whether the attribute values match the associated shadow attribute values, as described in more detail above with reference to FIGS. 1-2. If the values do not match, method 300 may proceed to step 312. If the values do match, method 300 may proceed to step 314.

At step 312, method 300 may wait for a user of host IHS 104 to confirm configuration changes to host IHS 104, as described in more detail above with reference to FIGS. 1-2. Once the user has confirmed the change(s), method 300 may proceed to step 316, where method 300 may continue the boot process. Once the boot process has completed, method 300 may return to step 302.

At step 314, method 300 may skip user interaction for some or all of the configuration changes to host IHS 104, as described in more detail above with reference to FIGS. 1-2. Method 300 may then proceed to step 316, where method 300 may continue the boot process. Once the boot process has completed, method 300 may return to step 302.

Although FIG. 3 discloses a particular number of steps to be taken with respect to method 300, method 300 may be executed with more or fewer steps than those depicted in FIG. 3. In addition, although FIG. 3 discloses a certain order of steps comprising method 300, the steps comprising method 300 may be completed in any suitable order. For example, some steps of method 300 may be performed for certain attributes while other steps may be performed for other attributes.

What is claimed:

1. An information handling system for providing unattended out of band job execution, the system comprising:
a processor;
a memory communicatively coupled to the processor, the memory having stored thereon instructions that when read and executed cause the processor to:
schedule a job for execution by a host system;
determine an attribute value, the attribute value associated a component of the host system; and
determine a shadow attribute value, wherein the shadow attribute value is configured to identify a user interaction associated with a configuration change to the component.

2. The system of claim 1, wherein the component of the host system is a BIOS.

3. The system of claim 1, wherein the configuration comprises a change in an operating mode of the component.

4. The system of claim 1, wherein the shadow attribute value comprises a dependency value associated with the attribute value.

5. The system of claim 1, wherein the user interaction comprises a lack of user confirmation of the configuration change.

6. The system of claim 1, wherein the user interaction comprises a user confirmation of the configuration change.

7. An information handling system for providing unattended out of band job execution, the system comprising:
a processor;
a memory communicatively coupled to the processor, the memory having stored thereon instructions that when read and executed cause the processor to:
receive data associated with an attribute value, the attribute value associated with a component of the information handling system;
receive data associated with a shadow attribute value, the shadow attribute value associated with the component, wherein the shadow attribute value is configured to identify a user interaction associated with a configuration change to the component;
set the attribute value and the shadow attribute value; and
compare the attribute value and the shadow attribute value to determine the user interaction.

8. The system of claim 7, wherein the component of the host system is a BIOS.

9. The system of claim 7, wherein the configuration comprises a change in an operating mode of the component.

10. The system of claim 7, wherein the shadow attribute value comprises a dependency value associated with the attribute value.

11. The system of claim 7, wherein the user interaction comprises a lack of user confirmation of the configuration change.

12. The system of claim 7, wherein the user interaction comprises a user confirmation of the configuration change.

13. A method for providing unattended out of band job execution, the method comprising:
scheduling a job for execution by a host system;
determining an attribute value, the attribute value associated a component of the host system; and
determining a shadow attribute value, wherein the shadow attribute value is configured to identify a user interaction associated with a configuration change to the component.

14. The method of claim 13, wherein the component of the host system is a BIOS.

15. The method of claim 13, wherein the configuration comprises a change in an operating mode of the component.

16. The method of claim 13, wherein the shadow attribute value comprises a dependency value associated with the attribute value.

17. The method of claim 13, wherein the user interaction comprises a lack of user confirmation of the configuration change.

18. The method of claim 13, wherein the user interaction comprises a user confirmation of the configuration change.
